(19) United States
(12) Patent Application Publication
(10) Pub. No.: US 2026/0293952 A1
(43) Pub. Date: Oct. 1, 2026

(54) METHOD FOR PREPARING AN ORGANIC LOW-SODIUM GREEN SALT FROM MARINE GREEN PLANTS

(71) Applicant: GOODDAYS 4VEER LLC, Newark, DE (US)

(72) Inventors: Chaitanya Pandey, Issaquah, WA (US); Simmy Sharma, Issaquah, WA (US)

(21) Appl. No.: 19/379,485

(22) Filed: Nov. 4, 2025

Related U.S. Application Data
(60) Provisional application No. 63/777,810, filed on Mar. 26, 2025.

(51) Int. Cl. A23L 27/40

(52) U.S. Cl. CPC A23L 27/45

(57) ABSTRACT

A method of preparing an organic, low-sodium, mineral-rich, plant-based salt from Salicornia plants offering a healthy alternative to conventional high-sodium salts is provided. The method includes collecting fresh Salicornia plants grown in a saline condition and cleaning the plants to remove contaminants followed by air-drying. The cleaned plants are finely chopped to ensure uniform dehydration. The chopped plant materials are dehydrated by (i) initially exposing the chopped plant materials to a hot air with a dehydration temperature of about 35° C. for 3 hours in a dehydrator, and (ii) gradually increasing the dehydration temperature of the hot air to 45° C.-60° C. over a period of 12-15 hours to synthesize dried plant materials. This gradual increase of the dehydration temperature prevents charring and retains up to 90% of nutrient compounds naturally available in the plants. The dried plant materials are ground into a fine green powder, resulting in a preservative-free, additive-free, low-sodium plant-based green salt promoting better health and sustainability.

### BACKGROUND

### Technical Field

The present invention relates to a plant-based green salt, and more particularly relates to an organic, low-sodium green salt prepared using marine plants that contains no preservatives or additives and preserves the plant's naturally occurring minerals, vitamins, and beneficial compounds. Moreover, the present invention relates to a method of preparing an organic, low-sodium green salt prepared using marine plants.

### Description of the Related Art

Globally, the increasing prevalence of hypertension, diabetes, and cardiovascular diseases has been strongly linked to excessive sodium intake in human diets. Typical human diets rely on salt, a primary source of sodium chloride, which enhances the taste of food and extends the shelf life of the food. However, the regular consumption of common salt, which is high in sodium, significantly exacerbates health risks, often resulting in sodium intake exceeding the daily recommended allowance by approximately 45%. Such excessive consumption of common salt (e.g. sodium chloride) poses several health risks, as highlighted by the United States Food and Drug Administration (USFDA), which recommends limiting daily sodium intake to 2,300 mg for most adults. However, the average intake often exceeds this limit, leading to adverse effects such as hypertension (high blood pressure), cardiovascular issues, kidney damage, obesity, and fluid retention (edema). The high sodium content in common salt significantly contributes to hypertension, as it increases blood volume and pressure, thereby elevating the risk of stroke and heart disease. Additionally, excessive sodium intake strains the heart and blood vessels, which may lead to heart failure and other cardiovascular complications. The kidneys are also adversely affected, as they work harder to filter excess sodium, potentially leading to chronic kidney disease (CKD) or kidney stones, which form due to crystal accumulation. Furthermore, high sodium intake has been linked to weight gain and obesity, as excessive salt consumption can alter metabolism and increase water retention. This fluid retention (edema) causes swelling in the hands, feet, and other body parts, leading to discomfort and potential health complications.

The increasing awareness of the health risks associated with excessive sodium intake has led to the development of various salt substitutes as alternatives to conventional sodium chloride (NaCl)-based common salt. Among these alternatives, potassium chloride (KCl) is one of the most widely used salt substitutes due to its ability to provide a salty taste with reduced sodium content. However, potassium chloride-based salt substitutes present several limitations and health concerns that restrict their widespread adoption. For individuals with kidney disease or those taking medications that affect potassium levels, such as ACE inhibitors or potassium-sparing diuretics, excessive potassium intake can lead to hyperkalemia, a condition characterized by dangerously high potassium levels, which can cause cardiac arrhythmias and other serious health complications. Additionally, potassium chloride-based salt substitutes have limited culinary applications, as they may not be suitable for baking, food preservation, or recipes where sodium chloride plays a structural role. Moreover, excessive consumption of these substitutes can lead to nutritional imbalances, particularly due to high levels of potassium or magnesium, which may cause adverse effects such as gastrointestinal discomfort, muscle weakness, or metabolic disturbances. Further, these salt substitutes do not provide sodium, which is an important ion required for body functioning. Because, sodium is essential for maintaining fluid balance, nerve signaling, and muscle contractions. The brain also requires both sodium and potassium for proper neurotransmission and overall cerebral function. Reducing sodium and potassium too much can lead to issues like fatigue, dizziness, confusion, and poor muscle coordination.

The need for healthier alternatives has led to the exploration of plant based low-sodium salt substitutes derived from marine green plants. Salicornia brachiate is the suitable example of a marine green plant which is a halophytic (salt-tolerant) plant naturally found in coastal regions, salt marshes, and mangrove ecosystems. This Salicornia brachiate plant has unique ability to absorb salinity from seawater and store salt within its succulent stems, allowing it to thrive in high-salinity environments where most conventional plants cannot survive. Due to its natural salt-accumulating properties, Salicornia has been explored as a functional food ingredient and a natural source of low-sodium salt substitutes. The plant-based salt substitutes provide a natural and healthier alternative to commercially available high-sodium common salt. However, existing methods for producing plant-derived salts often involve complex dehydration processes, which can lead to the loss of naturally occurring nutrients such as minerals, vitamins, and other bioactive compounds beneficial to human health.

Existing methods for preparing low-sodium salt substitutes from natural green sources involve complex and costly processes. An existing method of preparing such low-sodium salts often requires the inclusion of preservatives, and additives to extend the shelf life that introduces additional health risks. Existing processes for obtaining substitute salts from natural plant sources typically involve extracting juice through squeezing techniques, followed by concentration, crystallization, and drying it to produce plant-based organic salt. These processes are resource-intensive, involve high-temperature drying, and result in the degradation of natural minerals, vitamins, and other essential nutrients available in the plants. For example, high-temperature drying and crystallization often lead to the breakdown of heat-sensitive vitamins, the denaturation of bioactive proteins, and the destruction of natural pigments such as chlorophyll and carotenoids that contribute both to nutritional value and to the characteristic green color. Moreover, essential minerals and trace elements may be lost or structurally altered during concentration and crystallization steps. As a result, the final product often lacks the full spectrum of naturally occurring nutrients and beneficial compounds originally present in the plant source.

Accordingly, there is a need for a simple and cost-effective method of preparing an organic, low-sodium green salt from marine plants that preserves the naturally occurring minerals, vitamins, and beneficial compounds of the plant while eliminating the need for additives or complex arrangements.

### SUMMARY

In view of a foregoing, an embodiment herein provides a method of preparing a low-sodium green salt from marine plants with preserved nutrients and natural color. The method includes (a) preparing chopped plant materials by chopping cleaned marine plants into small pieces using a cutting unit; (b) performing a dehydration process on the chopped plant materials using a dehydrator, where the dehydration process includes (i) initially exposing the chopped plant materials to a hot air with a dehydration temperature of about 35° C. for 3 hours in the dehydrator, and (ii) gradually increasing the dehydration temperature of the hot air to 45° C.-60° C. over a period of 12-15 hours to synthesize dried plant materials; and (c) grinding the dried plant materials into a powder using a grinding unit to synthesize green salt that has a low-sodium and preserves nutrient compounds and natural color of the marine plants.

In some embodiments, the cleaned marine plants are prepared by (i) collecting marine plants that are collected from an area or a saline environment; (ii) pre-washing the marine plants to remove dirt, soil particles, sand, or debris; (iii) rinsing the marine plants under running water and draining the water from the rinsed plants; and (iv) drying the drained plants using an air dryer to remove residual water before dehydration.

In some embodiments, the marine plants include Salicornia species.

In some embodiments, the Salicornia species is Salicornia brachiata.

In some embodiments, the chopped plant materials are dehydrated by placing the chopped plants in a single layer on a series of steel-wired mesh trays in the dehydrator.

In some embodiments, the dehydration temperature of the hot air is gradually increased to 45° C. for 5 hours, followed by 55° C. for 5 hours, and then to 60° C. for 2 hours.

In some embodiments, the hot air is generated by heating the air within a dehydration chamber possessing the chopped plant materials using an electric heating element and circulated uniformly across the chopped plant materials to absorb moisture, where a moisture-laden air is expelled from the dehydration chamber to maintain a dry environment.

In some embodiments, the hot air is generated by operating a refrigerant-based heat pump cycle, where a refrigerant (i) absorbs heat from ambient air using an evaporator, (ii) compresses to increase its temperature and pressure using a compressor, (iii) releases the absorbed heat into the dehydration chamber using a condenser, and (iv) expands to absorb heat again.

In some embodiments, the green salt includes the low sodium content of about 12.33 to 13.07 grams (g) per 100 grams (g) of the green salt.

In some embodiments, the green salt includes (i) potassium of about 1.29 to 1.57 g, (ii) calcium of about 455 to 470.75 mg, (iii) iron of about 18.75 to 23.95 mg, (iv) magnesium of about 521.4 to 776.24 mg, (v) barium of about 0.065 to 0.084 mg (vi) manganese of about 1.99 to 2.38 mg, (vii) zinc of about 2.271 to 2.375 mg, (viii) copper of about 0.72 to 0.73 mg, (ix) selenium of about less than 0.05 mg and (x), phosphorous of about 56.9 to 57 mg, (xi) chloride of about 22.83 to 23.08 mg, and (xii) iodine of about 430.6 to 689.4 micrograms (μg) per 100 g of the green salt.

In some embodiments, the green salt includes vitamins including (i) Vitamin B1 in an amount of 0.087 to 0.127 mg, (ii) Vitamin B2 in an amount of 0.538 to 0.948 mg, (iii) Vitamin B3 in an amount of 2.487 to 2.775 mg, (iv) Vitamin B5 in an amount of 1.263 to 1.666 mg, (v) Vitamin B6 in an amount of 0.211 to 0.228 mg, (vi) Vitamin B7 in an amount of 0.02 to 0.023 mg, (vii) Vitamin B9 in an amount of less than about 0.001 mg, (viii) Vitamin B12 in an amount of less than about 0.001 mg, (ix) Vitamin E in an amount of about 4.992 to 5.217 μg, and (x) Vitamin D in an amount of less than about 10 μg per 100 grams of the green salt.

In some embodiments, the green salt includes omega fatty acids including (i) Omega 3 in an amount of <0.10 to 0.16 g, (ii) Omega 6 in an amount of 0.17 to 0.27 g, and (iii) Omega 9 in an amount of <0.10 to 0.11 g per 100 grams of green salt.

In one aspect, a method of preparing a low-sodium green salt from Salicornia brachiata with preserved nutrients and natural color is provided. The method includes (a) preparing chopped Salicornia plant materials by chopping Salicornia plants into small pieces using a cutting unit; (b) performing a dehydration process on the chopped Salicornia plant materials using a dehydrator, where the dehydration process includes (i) placing the chopped Salicornia plant materials in a single layer on a series of steel-wired mesh trays in the dehydrator, (ii) initially exposing the chopped Salicornia plant materials to a hot air with a dehydration temperature of about 35° C. for 3 hours in the dehydrator, and (iii) gradually increasing the dehydration temperature of the hot air to 45° C.-60° C. over a period of 12-15 hours to synthesize dried Salicornia plant materials; and (c) grinding the dried plant materials into a powder using a grinding unit to synthesize green salt that has a low-sodium content of about 12.33 to 13.07 grams (g) per 100 g.

In some embodiments, the dehydration process optionally includes performing dehumidification using a dehumidification system that removes moisture from the chopped Salicornia plant materials and surrounding environment and expels the removed moisture in liquid form.

In some embodiments, the green salt includes (i) potassium of about 1.29 to 1.57 g, (ii) calcium of about 455 to 470.75 mg, (iii) iron of about 18.75 to 23.95 mg, (iv) magnesium of about 521.4 to 776.24 mg, (v) barium of about 0.065 to 0.084 mg (vi) manganese of about 1.99 to 2.38 mg, (vii) zinc of about 2.271 to 2.375 mg, (viii) copper of about 0.72 to 0.73 mg, (ix) selenium of about less than 0.05 mg and (x), phosphorous of about 56.9 to 57 mg, (xi) chloride of about 22.83 to 23.08 mg, and (xii) iodine of about 430.6 to 689.4 micrograms (μg) per 100 g of the green salt.

In some embodiments, the green salt includes vitamins including (i) Vitamin B1 in an amount of 0.087 to 0.127 mg, (ii) Vitamin B2 in an amount of 0.538 to 0.948 mg, (iii) Vitamin B3 in an amount of 2.487 to 2.775 mg, (iv) Vitamin B5 in an amount of 1.263 to 1.666 mg, (v) Vitamin B6 in an amount of 0.211 to 0.228 mg, (vi) Vitamin B7 in an amount of 0.02 to 0.023 mg, (vii) Vitamin B9 in an amount of less than about 0.001 mg, (viii) Vitamin B12 in an amount of less than about 0.001 mg, (ix) Vitamin E in an amount of about 4.992 to 5.217 μg, and (x) Vitamin D in an amount of less than about 10 μg per 100 grams of the green salt.

In another aspect, a method of preparing a low-sodium green salt from Salicornia brachiata with preserved nutrients and natural color is provided. The method includes (a) preparing chopped Salicornia plant materials by chopping Salicornia plants into small pieces using a cutting unit; (b) performing a dehydration process on the chopped Salicornia plant materials using a dehydrator, where the dehydration process includes (i) initially exposing the chopped Salicornia plant materials to a hot air with a dehydration temperature of about 35° C. for 3 hours in the dehydrator, and (ii) gradually increasing the dehydration temperature of the hot air to about 45° C.-60° C. over a period of 12-15 hours to synthesize dried Salicornia plant materials; and (c) grinding the dried plant materials into a powder using a grinding unit to synthesize green salt that has a low-sodium content of about 12.33 to 13.07 grams (g) and a high potassium content of about 1.29 to 1.57 g per 100 g.

In some embodiments, the green salt includes (i) calcium of about 455 to 470.75 mg, (ii) iron of about 18.75 to 23.95 mg, (iii) magnesium of about 521.4 to 776.24 mg, (iv) barium of about 0.065 to 0.084 mg (v) manganese of about 1.99 to 2.38 mg, (vi) zinc of about 2.271 to 2.375 mg, (vii) copper of about 0.72 to 0.73 mg, (viii) selenium of about less than 0.05 mg and (ix), phosphorous of about 56.9 to 57 mg, (x) chloride of about 22.83 to 23.08 mg, and (xi) iodine of about 430.6 to 689.4 micrograms (μg) per 100 g of the green salt.

In some embodiments, the green salt includes vitamins including (i) Vitamin B1 in an amount of 0.087 to 0.127 mg, (ii) Vitamin B2 in an amount of 0.538 to 0.948 mg, (iii) Vitamin B3 in an amount of 2.487 to 2.775 mg, (iv) Vitamin B5 in an amount of 1.263 to 1.666 mg, (v) Vitamin B6 in an amount of 0.211 to 0.228 mg, (vi) Vitamin B7 in an amount of 0.02 to 0.023 mg, (vii) Vitamin B9 in an amount of less than about 0.001 mg, (viii) Vitamin B12 in an amount of less than about 0.001 mg, (ix) Vitamin E in an amount of about 4.992 to 5.217 μg, and (x) Vitamin D in an amount of less than about 10 μg per 100 grams of the green salt.

In some embodiments, the green salt includes omega fatty acids including (i) Omega 3 in an amount of <0.10 to 0.16 g, (ii) Omega 6 in an amount of 0.17 to 0.27 g, and (iii) Omega 9 in an amount of <0.10 to 0.11 g per 100 grams of green salt.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications

### BRIEF DESCRIPTION OF THE DRAWINGS

The embodiments herein will be better understood from the following detailed description with reference to the drawings, in which:

FIG. 1 is a flow diagram that illustrates a method of preparing an organic, plant-based low-sodium green salt from marine plants according to some embodiments herein;

FIG. 2 is a block diagram that illustrates a system for preparing an organic, plant-based low-sodium green salt from Salicornia plants using a method of FIG. 1 according to some embodiments herein; and

FIGS. 3A-3B illustrate pictorial representations of an organic, low-sodium, mineral-rich plant-based green salt prepared using a method of FIG. 1 according to some embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As mentioned, there remains a need for a simple and cost-effective method for preparing an organic, low-sodium green salt from marine plants that preserves naturally occurring minerals, vitamins, and beneficial compounds of the plant while eliminating the need for additives or complex arrangements. The embodiments herein achieve this by providing a method for preparing an organic, low-sodium green salt from marine plants, where the method retains the naturally occurring minerals, vitamins, and beneficial compounds of the plant while eliminating the need for additives or preservatives. The resulting organic, low-sodium plant based green salt serves as a substitute for high-sodium salt, thereby supporting overall well-being of humans and enhancing immunity, thus providing a healthier and more sustainable alternative to conventional high-sodium salts.

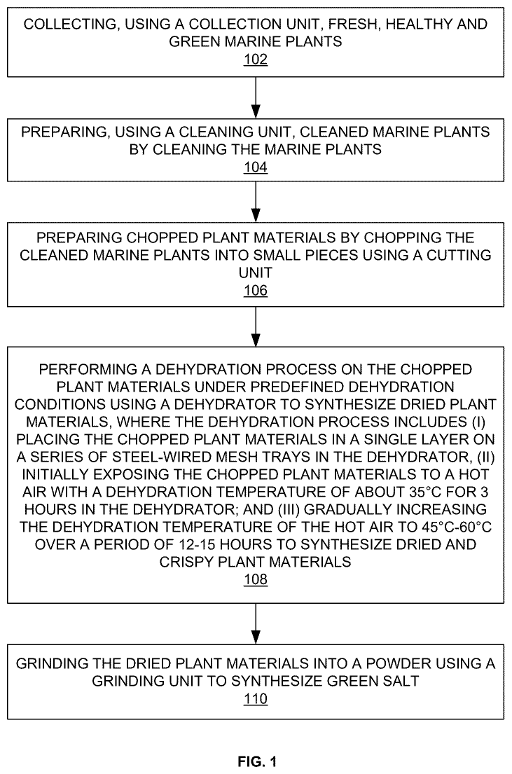

Referring now to the drawings, and more particularly to FIGS. 1 through 3, where similar reference characters denote corresponding features consistently throughout the figures, preferred embodiments are shown.

As used herein, several terms are defined below:

The term “organic” refers to products that are grown or processed naturally without the use of synthetic chemicals, such as fertilizers, pesticides, herbicides, and genetically modified organisms (GMOs).

The term “low-sodium” refers to a product that contains a reduced amount of sodium compared to regular or standard versions of similar products. Sodium is primarily found in salt (sodium chloride), and reducing its content is important for managing health risks such as hypertension, cardiovascular diseases, and kidney-related issues.

The term “salt” refers to sodium chloride but can also include other salts (like potassium salts) that may be used as substitutes or supplements. Salts play a critical role in maintaining electrolyte balance in the body.

The term “green marine plants” refers to aquatic or semi-aquatic plants that thrive in saline or brackish water environments, such as coastal areas, salt marshes, or other saline ecosystems. These plants are characterized by their natural green color, which is indicative of their rich chlorophyll content, and their ability to tolerate high salinity conditions. Examples include Salicornia and other halophyte species, which are known for their nutritional properties, including being rich in minerals, vitamins, and beneficial bioactive compounds.

The term “Green Salicornia plants” refers to species of the genus Salicornia, which are halophytic (salt-tolerant) plants commonly found in saline or brackish water environments such as coastal areas, salt marshes, and estuaries. Salicornia plant is rich in essential minerals such as magnesium, potassium, calcium, and iron, which are beneficial for human health. Additionally, Salicornia contains bioactive compounds, including antioxidants, vitamins, and dietary fiber, which contribute to its nutritional value. Given its potential as a natural, mineral-rich, low-sodium alternative to common salt, Salicornia-based salt offers a promising solution for individuals seeking to reduce sodium intake while maintaining essential nutrient balance.

The term “dehydration process” refers to a method of removing moisture from a substance, such as plants or other organic materials, to achieve a dried state while preserving the integrity of the material.

The term “dehumidification system” refers to a mechanism or process designed to reduce and control the humidity levels in a given environment by removing excess moisture from the air or surrounding materials.

FIG. 1 is a flow diagram that illustrates a method of preparing an organic, plant based low-sodium green salt from marine plants according to some embodiments herein. At step 102, the method includes collecting fresh, healthy and green marine plants using a collection unit.

The collection unit may include at least one of a manual harvesting device, mechanical harvester, conveyor-based collection system, robotic picker, or suction-based collection mechanism. The marine plants are collected from a source station including, but not limited to, a coastal area or a saline environment. In some embodiments, the marine plants include Salicornia species. In some embodiments, the Salicornia species include Salicornia brachiata.

At step 104, the method includes preparing cleaned marine plants by cleaning the marine plants using a cleaning unit. The cleaning unit may include at least one of a washing tank with bubble agitation, a spray washer with high-pressure nozzles, a rotary drum washer, an ultrasonic cleaning system, or a conveyor-based rinsing mechanism, optionally followed by an air-knife or blower-based surface drying system. In some embodiments, the cleaned marine plants are prepared by (i) pre-washing the marine plants thoroughly to remove dirt, soil particles, sand, or debris; (ii) rinsing the marine plants under running water in the cleaning unit and draining the water from the rinsed plants; and (iii) drying the drained plants using an air dryer to remove residual water before dehydration. The air dryer may be at least one of a tray drier, a tunnel drier, a conveyor belt dryer, a hot air circulation dryer, a cabinet dryer, a mesh rack with fans or a combination thereof.

At step 106, the method includes preparing chopped plant materials by chopping the cleaned marine plants into small pieces using a cutting unit. This pre-preparation stage before a dehydration process increases the surface area of the chopped plant materials exposed to heat, thereby facilitating uniform dehydration and minimizing the risk of incomplete drying or charring of the plant materials. The cutting unit may be a manual chopping device, an electric chopping device including, but not limited to, a rotary cutting machine, a bowl chopper, a high-speed pulverizer, or a customized multi-functional blade chopping machine, a commercial chopping device, an industrial chopping machine, or any other custom chopping solution that can be selected based on the scale of operation.

At step 108, the method includes performing the dehydration process on the chopped plant materials under predefined dehydration conditions using a dehydrator to synthesize dried plant materials. The dehydration process includes (i) placing the chopped plant materials evenly or in a single layer on a series of steel-wired mesh trays in the dehydrator, (ii) initially exposing the chopped plant materials to a hot air with a dehydration temperature of about 35° C. for 3 hours in the dehydrator; and (iii) gradually increasing the dehydration temperature of the hot air to 45° C.-60° C. over a period of 12-15 hours to synthesize dried and crispy plant materials. The dehydration process retains up to 90% of nutrient compounds naturally available in the plants.

In some embodiments, the dehydration temperature of the hot air is gradually increased to 45° C. for 5 hours, followed by 55° C. for 5 hours, and then to 60° C. for 2 hours. This gradual increase in the dehydration temperature prevents charring of the chopped plant materials and ensures preservation of naturally occurring nutritional content, while removing moisture.

The hot air may be generated by the dehydrator. The dehydrator may be at least one of a heat pump dehydrator, a hot air dehydrator including, but not limited to, a tray-based hot air dehydrator, a continuous conveyor belt dehydrator, a batch airflow dryer, a stackable tray dehydrator, a rotary drum dryer, and a cabinet dryer with humidity control, a freeze-vacuum dryer, a vacuum dehydrator, a solar-powered dehydrator, a microwave-assisted dehydrator, a custom-built dehydrator, or a combination thereof.

In some embodiments, the dehydrator is the hot air dehydrator that includes a dehydration chamber in which the chopped plant materials are placed, an electric heating element, and a built-in fan. The hot air is generated by heating the air within the dehydration chamber possessing the chopped plant materials using the electric heating element. The hot air is further circulated uniformly across the chopped plant materials using the built-in fan to absorb moisture. A moisture-laden air is expelled from the dehydration chamber to maintain a dry environment.

In some embodiments, the dehydrator is a heat pump dehydrator. The heat pump dehydrator includes a dehydration chamber in which the chopped plant materials are placed, a refrigerant, an evaporator, a compressor, a condenser, and an expansion valve. With this dehydrator, the hot air is generated by operating a refrigerant-based heat pump cycle, where a refrigerant (i) absorbs heat from ambient air using the evaporator, (ii) compresses to increase its temperature and pressure using the compressor, (iii) releases the absorbed heat into the dehydration chamber using the condenser, and (iv) expands to absorb heat again through the expansion valve. This valve may regulate the flow of the refrigerant into the evaporator.

In some embodiments, the dehydration process optionally includes performing dehumidification using a dehumidification system. The dehumidification removes moisture from the chopped plant materials and surrounding environment and expels the removed moisture in liquid form.

In some embodiments, the dehydration process further includes employing a continuous monitoring capability for monitoring moisture levels and air temperature and regulating drying conditions to ensure optimal dehydration.

At step 110, the method includes grinding the dried plant materials into a powder using a grinding unit to synthesize green salt. In some embodiments, the grinding unit includes at least one of a burr grinder, a hammer grinder, a disc grinder, an herb grinder, an ultra-fine pulverizer, a cryogenic grinder, a pin mill, a blender-based grinder, a continuous ball mill, a turbo mill, a micronizer, or a combination thereof.

The resulting green salt has a reduced sodium content and retains the naturally occurring nutrient compounds, minerals, and pigments responsible for the natural green color of the marine plants. The green salt is free from preservatives and chemical additives, thereby maintaining its organic nature. The natural composition and nutrient profile of the green salt make it a healthier alternative to conventional high-sodium salts, supporting overall well-being and providing a sustainable substitute for chemically processed salt products.

The green salt includes a low sodium content of about 12.33 to 13.07 grams (g) per 100 grams (g) of the green salt.

Further, the green salt delivers potassium, magnesium, calcium, and other essential minerals inherent to the marine plants, while providing a natural, reduced-sodium alternative to conventional salt. In some embodiments, the green salt includes (i) potassium of about 1.29 to 1.57 g, (ii) calcium of about 455 to 470.75 mg, (iii) iron of about 18.75 to 23.95 mg, (iv) magnesium of about 521.4 to 776.24 mg, (v) barium of about 0.065 to 0.084 mg (vi) manganese of about 1.99 to 2.38 mg, (vii) zinc of about 2.271 to 2.375 mg, (viii) copper of about 0.72 to 0.73 mg, (ix) selenium of about less than 0.05 mg and (x), 56.9 to 57 mg of phosphorous, (xi) 22.83 to 23.08 mg of chloride, and (xii) 430.6 to 689.4 micrograms (μg) of iodine per 100 g of the green salt.

The green salt further delivers vitamins comprising (i) Vitamin B1 in an amount of 0.087 to 0.127 mg, (ii) Vitamin B2 in an amount of 0.538 to 0.948 mg, (iii) Vitamin B3 in an amount of 2.487 to 2.775 mg, (iv) Vitamin B5 in an amount of 1.263 to 1.666 mg, (v) Vitamin B6 in an amount of 0.211 to 0.228 mg, (vi) Vitamin B7 in an amount of 0.02 to 0.023 mg, (vii) Vitamin B9 in an amount of less than about 0.001 mg, (viii) Vitamin B12 in an amount of less than about 0.001 mg, (ix) Vitamin E in an amount of about 4.992 to 5.217 μg, and (x) Vitamin D in an amount of less than about 10 μg per 100 grams of the green salt.

The green salt further includes omega fatty acids including (i) Omega 3 in an amount of <0.10 to 0.16 g, (ii) Omega 6 in an amount of 0.17 to 0.27 g, and (iii) Omega 9 in an amount of <0.10 to 0.11 g per 100 grams of green salt.

In some embodiments, a method of preparing a low-sodium green salt from Salicornia brachiata includes (a) preparing chopped Salicornia plant materials by chopping Salicornia plants into small pieces using the cutting unit; (b) performing a dehydration process on the chopped Salicornia plant materials using the dehydrator by (i) placing the chopped Salicornia plant materials evenly on a series of steel-wired mesh trays in the dehydrator; (ii) initially exposing the chopped Salicornia plant materials to a hot air at a dehydration temperature of about 35° C. for 3 hours in the dehydrator, and (iii) gradually increasing the dehydration temperature to about 45° C.-60° C. over a period of 12-15 hours to synthesize dried Salicornia plant materials; and (c) grinding the dried Salicornia plant materials into a powder using the grinding unit to synthesize green salt. The green salt has a low-sodium content of about 12.33 to 13.07 grams and a high potassium content of about 1.29 to 1.57 g per 100 grams with preserved nutrients and natural color.

TABLE 1 illustrates experimental procedures utilized for preparing Salicornia green salt under varying dehydration methods and conditions. These experiments are conducted to determine an optimized dehydration process that preserves the plant's naturally occurring nutritional content while producing a high-quality green salt product.

TABLE 1

| | | Drying | | |
|---|---|---|---|---|
| | | Condition | | |
| Trail | Drying | (Time and | Resulting | Obser- |
| No .: | Method | temperature) | Color | vations |
| I | Sun-dried | 3-4 days; | Dark | Salty |
| | Method | Ambient | Brown | Taste, |
| | | | | but not |
| | | | | retain |
| | | | | the color |
| II | Small | 34-36 | Brown | Effective |
| | electric | hours; | | dehy- |
| | dehydrator | 70º C. | | dration |
| | | | | but the |
| | | | | color is |
| | | | | not |
| | | | | retained |
| III | Air-dried | 4-5 days; | — | Uniform |
| | (indoor) | Ambient | | process, |
| | | (room | | but the |
| | | temp) | | color is |
| | | | | not |
| | | | | retained |
| | | | | effec- |
| | | | | tively |
| IV | Dehydrator | 30-32 | Green | First |
| | (Controlled | hours; | | successful |
| | temp) | 45° C. | | green |
| | | | | powder |
| | | | | (Salicornia |
| | | | | Green |
| | | | | Salt) |
| | | | | but the |
| | | | | preser - |
| | | | | vation |
| | | | | of natural |
| | | | | is not |
| | | | | effec- |
| | | | | tively |
| | | | | retained |
| V | Heat Pump | 12-15 | Green | First |
| | Dehydrator | hours; | | successful |
| | (with | 50° C. | | green |
| | dehumidi- | | | powder |
| | fication | | | and Pre- |
| | mechanism) | | | served |
| | | | | nutrients |
| | | | | and |
| | | | | color |
| | | | | most ef- |
| | | | | fectively |

From above TABLE 1, the trails are carried out with the plant species Salicornia brachiata to develop an optimized method for producing Salicornia green salt that retains its natural green color and preserves its nutritional properties. The primary objective of conducting experiments under various dehydration conditions is to determine a dehydration process that maintains the integrity of the plant species Salicornia Brachiata, thereby ensuring a stable, high-quality, and nutritionally rich end product suitable for commercial use.

Trial I is conducted using a traditional sun drying method with the freshly harvested Salicornia brachiata plants, approximately 2 kg in quantity. The collected plants are cleaned and laid out in an open area exposed to full sunlight with adequate airflow. The drying process in Trail I is lasted for three to four days to achieve complete dehydration of the plants, resulting in dried plant materials. After drying, the moisture content of the dried plant materials is measured and is ground into a powdered form. The resulting product is dark brown in color with a salty taste, however, does not retain the expected green hue.

Trial II is conducted using an electric dehydrator method (EDM), in which a small electric dehydrator is employed to dry freshly harvested and cleaned Salicornia brachiata plants. The plants are arranged in a single layer on dehydrator trays and subjected to a controlled temperature of 70° C. for a period of 34 to 36 hours, with periodic monitoring to ensure uniform drying. Analysis of the final product reveals that although the salty taste is retained, the resulting product turns into a brown color, indicating that high-temperature drying fails to preserve the natural green pigmentation of the plant.

Trial III is conducted using an air-drying method in a sheltered environment, away from direct sunlight. The drying process takes place indoors in a well-ventilated space to facilitate the natural dehydration of Salicornia brachiata plants. The plants are evenly spread out and left to air dry for a duration of four to five days. Periodic monitoring is performed to ensure uniform drying, including occasional turning of the plants to promote even moisture removal. After completion of the drying process, the dried plant material is ground into a fine powder using a clean, dry grinder or food processor. Trial III demonstrates that, while this method ensures uniform drying, it does not effectively retain the plant's natural color and nutrition properties effectively.

Trial IV is conducted using a controlled-temperature dehydration method involving an electric dehydrator with a precisely regulated temperature setting. Freshly harvested Salicornia brachiata plants are thoroughly cleaned, rinsed, and finely chopped before being subjected to dehydration. The drying process is maintained at a controlled temperature of approximately 45° C. for the duration of 30 to 32 hours, ensuring a gradual drying process that removes moisture while preventing charring and preserving the plant's nutritional composition. Following dehydration, the dried plant material is ground into a fine powder using a clean, dry grinder or food processor. The resultant product is a green-colored powdered salt, which is subsequently analyzed for its nutrient profile. The nutrient composition of the resultant salt (presented later in TABLE 2) confirms the effectiveness of the controlled-temperature dehydration method in preserving the plant's natural pigmentation and retaining essential nutrients, including vitamin A, vitamin B3, magnesium, potassium, and iron.

Trial V is conducted using a heat pump dehydrator with a dehumidification system. The method used in Trial V includes harvesting, cleaning, rinsing, and finely chopping the plants before dehydration. The drying process begins with the application of low-temperature hot air at 35° C. and is gradually increased to 45° C.-50° C. over 12 to 15 hours to obtain dried plant material. After drying, the dried plant material is ground into a fine powder using a clean, dry grinder or food processor to obtain a powdered salt. The resultant powdered salt is identified as Salicornia green salt, achieving the best balance between drying efficiency, nutrient preservation, and color retention. Trial V demonstrates that the dehumidification mechanism effectively removes moisture from the surroundings without excessive heat application, thereby ensuring optimal nutrient retention and color preservation.

The above conducted trials illustrate the progression toward an optimized drying process for producing Salicornia green salt. Traditional methods such as sun drying and air-drying result in significant color degradation and require prolonged processing times. High-temperature dehydration, as demonstrated in Trial II, accelerates drying but causes browning due to pigment loss. In Trial IV, controlled-temperature dehydration at 45° C. achieves a breakthrough by retaining the plant's natural green color. Further optimization in Trial V, utilizing heat pump dehydration with dehumidification mechanism, reduces the drying time to 12-15 hours while maximizing nutrient retention and color preservation of the final product. The findings from these trials highlight a novel and efficient method for producing Salicornia green salt, as a natural alternative to synthetic salt substitutes. The optimized dehydration method described in trail V preserves essential minerals such as Vitamin A, Vitamin B3, Magnesium, Potassium, and Iron, making the product suitable for commercial production and consumer use. This advancement delivers a high-quality final product with improved shelf stability, taste, and nutritional benefits.

TABLE 2 illustrates a nutritional profile including chemical constituents and other beneficial bio-compounds of the organic low-sodium and potassium-rich green salt derived from Salicornia plants using the method described in FIG. 1 of the present disclosure.

TABLE 2

| | | | | | |
|---|---|---|---|---|---|
| | | | | Limit of | |
| S. | | | | quantification | |
| No.: | Name of the test | Unit | Result | (LOQ) | Method of analysis |

FOOD CHEMICAL PARAMETERS

| | | | | |
|---|---|---|---|---|
| Added Sugar | g/1.5 g | <0.1 | — | IS 6287:2020 |
| Carbohydrate | g/1.5 g | 0.59 | — | FAO method no 2.3 |
| Energy | Kcal/1.5 gm | 3.26 | — | FAO method no 3.0 |
| Fat | g/1.5 g | <0.1 | — | IS 4684:2020 |
| Sugar | g/1.5 g | <0.1 | — | IS 6287:2020 |
| Protein | g/1.5 g | 0.16 | — | IS 7219:2020 |

INSTRUMENT TEST PARAMETERS

| | | | | |
|---|---|---|---|---|
| Calcium | mg/1.5 g | 14.85 | 0.00075 | SOP No. QP/DALPL/454 |
| Cholesterol | mg/1.5 g | <0.1 | 1.0 | SOP No. QP/DALPL/228 |
| Iron | mg/1.5 g | 0.34 | 0.00075 | SOP No. QP/DALPL/454 |
| Magnesium | mg/1.5 g | 16.31 | 0.00075 | SOP No. QP/DALPL/454 |
| Potassium | mg/1.5 g | 22.22 | 0.00075 | SOP No. QP/DALPL/454 |
| Saturated Fat | g/1.5 g | <0.1 | 1.0 | SOP No. QP/DALPL/229 |
| Sodium | mg/1.5 g | 190.50 | 0.00075 | SOP No. QP/DALPL/454 |
| Trans Fat | g/1.5 g | <0.1 | 1.0 | SOP No. QP/DALPL/229 |
| Vitamin A | mg/1.5 g | <0.00038 | 0.00038 | SOP No. QP/DALPL/596 |
| Vitamin B3 | mg/1.5 g | 2.72 | 0.0015 | SOP No. QP/DALPL/549 |
| Vitamin D | mg/1.5 g | <0.00038 | 0.00038 | SOP No. QP/DALPL/596 |

TABLE 3 illustrates approximate nutritional information, including chemical constituents and other beneficial bio-compounds, present in commonly available Morton and Redmond salt.

TABLE 3

| | Quantity available | | Quantity available | |
|---|---|---|---|---|
| | in Per 1.5 g | | in Per 1.5 g | |
| Nutritional/Chemical | serving of the | | serving of the | |
| compound | common Morton Salt | | common Redmond Salt | |
| Total Fat | 0 | mg | 0 | mg |
| Saturated fat | 0 | mg | 0 | mg |
| Cholesterol | 0 | mg | 0 | mg |
| Sodium | 590 | mg | 530 | mg |
| Potassium | 0.08 | mg | 0.08 | mg |
| Total Carbohydrate | 0 | mg | 0 | mg |
| Dietary fiber | 0 | mg | 0 | mg |
| Sugar | 0 | mg | 0 | mg |
| Protein | 0 | mg | 0 | mg |
| Calcium | 0 | mg | 0 | mg |
| Iron | 4 | mcg | 4 | mcg |
| Vitamin D | 0 | mg | 0 | mg |
| Vitamin B3 | 0 | mg | 0 | mg |
| Vitamin B6 | 0 | mg | 0 | mg |
| Vitamin B99 | 0 | mg | 0 | mg |
| Omega-3 fatty acids | 0 | mg | 0 | mg |
| Omega -6 Fatty acids | 0 | mg | 0 | mg |

TABLE 4 illustrates approximate nutritional information associated with Morton Salt substitute and Nu salt substitute.

TABLE 4

| | Quantity available | Quantity available |
|---|---|---|
| | in Per 1.5 g serving | in Per 1.5 g |
| Nutritional/Chemical | of the Morton | serving of the Nu |
| compound | salt substitute | salt substitute |
| Total Fat | 0 mg | 0 mg |
| Saturated fat | 0 mg | 0 mg |
| Cholesterol | 0 mg | 0 mg |
| Sodium | 0 mg | 0 mg |
| Potassium | 690 mg | 656 mg |
| Total Carbohydrate | 0 mg | 0 mg |
| Dietary fiber | 0 mg | 0 mg |
| Sugar | 0 mg | 0 mg |
| Protein | 0 mg | 0 mg |
| Calcium | 0 mg | 0 mg |
| Iron | 0 mg | 0 mg |
| Vitamin D | 0 mg | 0 mg |
| Vitamin B3 | 0 mg | 0 mg |
| Vitamin B6 | 0 mg | 0 mg |
| Vitamin B99 | 0 mg | 0 mg |
| Omega-3 fatty acids | 0 mg | 0 mg |
| Omega -6 Fatty acids | 0 mg | 0 mg |

The comparison of the nutritional information of common salt, commercial salts (e.g. Mortan or Redmond salt), salt substitutes (e.g. Morton Salt substitute and Nu salt substitute) and Salicornia green salt shows that the organic, plant based, low-sodium and potassium-rich green salt derived from Salicornia plants demonstrates superior nutritional benefits compared to common salt, commercial salts and salt substitutes. The Salicornia green salt is a minimally processed, organic, plant based, low-sodium and potassium-rich salt that retains a wide range of beneficial bio-compounds and nutrients naturally present in the Salicornia plants using a method described in FIG. 1 of the present disclosure. Unlike common salts, commercial salts and salt substitutes, which primarily consist of sodium chloride, and/or potassium chloride with minimal additional nutrients, Salicornia green salt contains significantly lower sodium levels (190.50 mg per 1.5 g) making it a healthier alternative for individuals seeking to manage sodium intake, particularly those with hypertension or cardiovascular concerns. The Salicornia green salt also provides essential minerals such as calcium (14.85 mg), magnesium (16.31 mg), iron (0.34 mg), and potassium (22.22 mg). Additionally, the Salicornia green salt offers beneficial bioactive compounds, including Vitamin B3 (2.72 mg), which are absent in traditional salts. This unique composition makes Salicornia green salt a healthier alternative, reducing sodium intake while delivering essential nutrients, thereby supporting cardiovascular health and overall well-being. Additionally, the green salt includes the rich mineral profile that makes it particularly suitable for use in dietary supplements and functional food formulations.

TABLE 5 illustrates a nutritional profile of Salicornia green salt at dehydration temperatures of 30° C. and 80° C.

TABLE 5

| Parameter | Unit in 100 grams | 30° C. | 80° C. |
|---|---|---|---|
| Vitamin B1 | mg/100 g | 0.127 | 0.087 |
| Vitamin B2 | mg/100 g | 0.948 | 0.538 |
| Vitamin B3 | mg/100 g | 2.775 | 2.487 |
| Vitamin B5 | mg/100 g | 1.666 | 1.263 |
| Vitamin B6 | mg/100 g | 0.211 | 0.228 |
| Vitamin B7 | mg/100 g | 0.023 | 0.02 |
| Vitamin B9 | mg/100 g | <0.001 | <0.001 |
| Vitamin B12 | mg/100 g | <0.001 | <0.001 |
| Vitamin D | μg/100 g | <10.0 | <10.0 |
| Potassium | mg/100 g | 1292.72 | 1570.64 |
| Barium | mg/kg | 0.84 | 0.65 |
| Calcium | mg/100 g | 470.75 | 455 |
| Iron | mg/100 g | 23.95 | 18.75 |
| Magnesium | mg/100 g | 521.4 | 776.24 |
| Manganese | mg/kg | 19.9 | 23.76 |
| Sodium | mg/100 g | 12334.23 | 13065.13 |
| Zinc | mg/kg | 23.75 | 22.71 |
| Copper | mg/kg | 7.28 | 7.17 |
| Selenium | mg/kg | <0.5 | <0.5 |
| Phosphorous | mg/kg | 570 | 568.64 |
| Chloride | mg/100 g | 22.83 | 23.08 |
| Iodine | μg/100 g | 430.6 | 689.4 |
| Omega-3 fatty acids | g/100 g | 0.16 | <0.10 |
| Omega -6 Fatty acids | g/100 g | 0.17 | 0.27 |
| Omega -9 Fatty acids | g/100 g | <0.10 | 0.11 |

As shown in TABLE 5, the results indicate that most nutrients, including essential vitamins (B1-B6, E), minerals (potassium, calcium, magnesium, iron, zinc, copper), and bioactive compounds remain relatively stable within this temperature range, with only minor variations observed. While certain heat-sensitive vitamins such as B1, B2, and B5 show slight reductions at 80° C., the overall nutritional composition, including potassium, magnesium, and iodine, remains well preserved. Omega-3 fatty acids exhibit a greater sensitivity, showing noticeable reduction at higher temperature. These findings indicate that nutrients in Salicornia green salt are largely stable between 30° C. and 80° C., with potential degradation occurring only beyond this range, emphasizing the importance of controlled low-temperature dehydration for maximum nutrient retention.

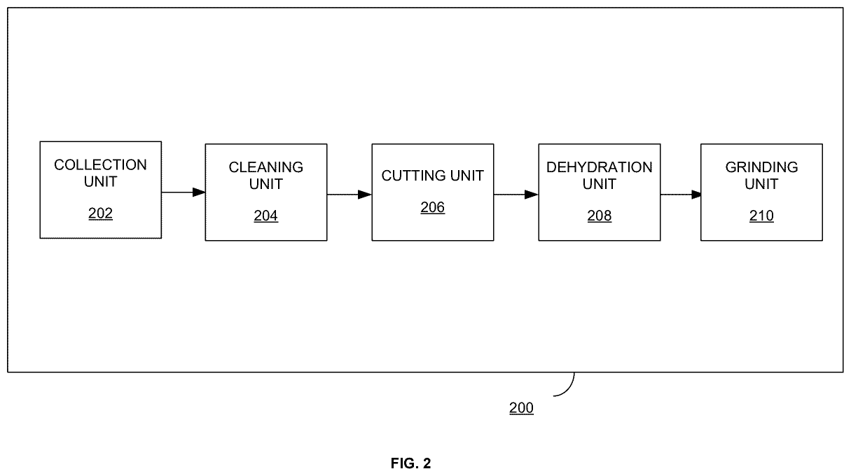

FIG. 2 is a block diagram that illustrates a system 200 for preparing an organic, plant-based low-sodium green salt from Salicornia plants using a method of FIG. 1 according to some embodiments herein. The system 200 includes a collection unit 202, a cleaning unit 204, a cutting unit 206, a dehydration unit 208, and a grinding unit 210. The collection unit 202 collects green Salicornia plants from a source station. The source station may be a coastal area or a saline environment. The cleaning unit 204 receives the collected Salicornia plants and rinses them under running water to remove dirt, debris, or any other contaminants. The rinsed plants are drained and air-dried thoroughly to evaporate the moisture, which ensures the preservation of the natural nutrients present in the plants. The cutting unit 206 receives the cleaned Salicornia plants for pre-preparation for a dehydration process. The cleaned Salicornia plants are chopped finely into small pieces to ensure uniform and effective dehydration. The dehydration unit 208 receives the chopped Salicornia plant materials from the cutting unit 206 and dehydrates the Salicornia plant materials at a predefined dehydration condition to obtain dried and crispy plant materials. The dehydration unit 208 may include a heat pump dehydrator and a series of steel-wired mesh trays. The chopped Salicornia plant materials are placed evenly on the steel-wired mesh trays. A controlled low-temperature hot air is passed initially at 35° C. for 3 hours and gradually increased to 45° C.-60° C. for 12-15 hours. The controlled gradual increase of the hot air over a period of 12 hours to 15 hours prevents charring of the Salicornia plant materials and ensures the preservation of the naturally available nutritional content of the Salicornia plant. The grinding unit 210 receives the dried and crispy Salicornia plant materials and grinds them into a fine green powder that is an organic, low-sodium, mineral-rich, plant-based salt. This resultant salt contains no preservatives or additives and is an effective substitute for high-sodium salt.

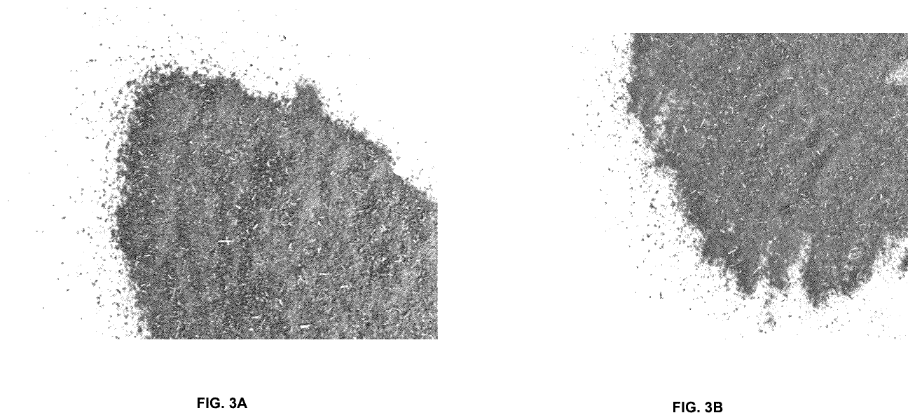

FIGS. 3A-3B illustrate pictorial representations of an organic, low-sodium, mineral-rich plant-based green salt prepared using a method of FIG. 1 according to some embodiments herein. The organic plant-based salt retains up to 90% of the plant's natural nutrients, including essential vitamins such as Vitamin A, B3, and D, as well as vital minerals such as Potassium, Magnesium, Calcium, and Iron, along with other beneficial bioactive compounds. Unlike conventional high-sodium salts, this organic low-sodium salt promotes a balanced sodium intake while enhancing dietary nutrition. Additionally, the green color of the salt, as revealed in FIGS. 3A and 3B, demonstrates the effective retention of the plant's natural pigmentation, indicating preservation of naturally available nutrient components during dehydration processing. This highlights the efficacy of the disclosed method in preserving the naturally occurring vitamins, minerals, and bioactive compounds of the plant, making it a healthier and nutrient-rich alternative to conventional salts.

The low-sodium, plant-based salt synthesized using a controlled low-temperature dehydration condition retains a natural salty flavor without a bitterness associated with the existing potassium chloride-based substitutes. The method of the present disclosure aligns with sustainable farming practices by conserving freshwater and utilizing marginal lands to provide a scalable solution that supports rural and coastal community livelihoods. The method of the present disclosure employs a simple and efficient process, thereby reducing complexity and production costs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

I/We claim:

1. A method of preparing a low-sodium green salt from marine plants with preserved nutrients and natural color, wherein the method comprises
preparing chopped plant materials by chopping cleaned marine plants into small pieces using a cutting unit;
characterized in that,
performing a dehydration process on the chopped plant materials using a dehydrator, wherein the dehydration process comprises,
(i) initially exposing the chopped plant materials to a hot air with a dehydration temperature of about 35° C. for 3 hours in the dehydrator, and
(ii) gradually increasing the dehydration temperature of the hot air to 45° C.-60° C. over a period of 12-15 hours to synthesize dried plant materials; and
grinding the dried plant materials into a powder using a dry grinding unit to synthesize green salt that has a low-sodium and preserves nutrient compounds and natural color of the marine plants.

2. The method of claim 1, wherein the cleaned marine plants are prepared by
(i) collecting marine plants, wherein the marine plants are collected from an area or a saline environment;
(ii) pre-washing the marine plants to remove dirt, soil particles, sand, or debris;
(iii) rinsing the marine plants under running water and draining the water from the rinsed plants; and
(iv) drying the drained plants using an air dryer to remove residual water before dehydration.

3. The method of claim 1, wherein the marine plants comprise Salicornia species.

4. The method of claim 3, wherein the Salicornia species comprise Salicornia brachiata.

5. The method of claim 1, wherein the chopped plant materials are dehydrated by placing the chopped plants in a single layer on a series of steel-wired mesh trays in the dehydrator.

6. The method of claim 1, wherein the dehydration temperature of the hot air is gradually increased to 45° C. for 5 hours, followed by 55° C. for 5 hours, and then to 60° C. for 2 hours.

7. The method of claim 1, wherein the hot air is generated by heating the air within a dehydration chamber possessing the chopped plant materials using an electric heating element and circulated uniformly across the chopped plant materials to absorb moisture, wherein a moisture-laden air is expelled from the dehydration chamber to maintain a dry environment.

8. The method of claim 1, wherein the hot air is generated by operating a refrigerant-based heat pump cycle, where a refrigerant (i) absorbs heat from ambient air using an evaporator, (ii) compresses to increase its temperature and pressure using a compressor, (iii) releases the absorbed heat into the dehydration chamber using a condenser, and (iv) expands to absorb heat again.

9. The method of claim 1, wherein the green salt comprises the low sodium content of about 12.33 to 13.07 grams (g) per 100 grams (g) of the green salt.

10. The method of claim 1, wherein the green salt comprises (i) potassium of about 1.29 to 1.57 g, (ii) calcium of about 455 to 470.75 mg, (iii) iron of about 18.75 to 23.95 mg, (iv) magnesium of about 521.4 to 776.24 mg, (v) barium of about 0.065 to 0.084 mg (vi) manganese of about 1.99 to 2.38 mg, (vii) zinc of about 2.271 to 2.375 mg, (viii) copper of about 0.72 to 0.73 mg, (ix) selenium of about less than 0.05 mg and (x), phosphorous of about 56.9 to 57 mg, (xi) chloride of about 22.83 to 23.08 mg, and (xii) iodine of about 430.6 to 689.4 micrograms (μg) per 100 g of the green salt.

11. The method of claim 1, wherein the green salt comprises vitamins comprising (i) Vitamin B1 in an amount of 0.087 to 0.127 mg, (ii) Vitamin B2 in an amount of 0.538 to 0.948 mg, (iii) Vitamin B3 in an amount of 2.487 to 2.775 mg, (iv) Vitamin B5 in an amount of 1.263 to 1.666 mg, (v) Vitamin B6 in an amount of 0.211 to 0.228 mg, (vi) Vitamin B7 in an amount of 0.02 to 0.023 mg, (vii) Vitamin B9 in an amount of less than about 0.001 mg, (viii) Vitamin B12 in an amount of less than about 0.001 mg, (ix) Vitamin E in an amount of about 4.992 to 5.217 μg, and (x) Vitamin D in an amount of less than about 10 μg per 100 grams of the green salt.

12. The method of claim 1, wherein the green salt comprises omega fatty acids including (i) Omega 3 in an amount of <0.10 to 0.16 g, (ii) Omega 6 in an amount of 0.17 to 0.27 g, and (iii) Omega 9 in an amount of <0.10 to 0.11 g per 100 grams of green salt.

13. A method of preparing a low-sodium green salt from Salicornia brachiata with preserved nutrients and natural color, wherein the method comprises
preparing chopped Salicornia plant materials by chopping Salicornia plants into small pieces using a cutting unit;
characterized in that,
performing a dehydration process on the chopped Salicornia plant materials using a dehydrator, wherein the dehydration process comprises
(i) placing the chopped Salicornia plant materials in a single layer on a series of steel-wired mesh trays in the dehydrator;
(ii) initially exposing the chopped Salicornia plant materials to a hot air with a dehydration temperature of about 35° C. for 3 hours in the dehydrator, and
(iii) gradually increasing the dehydration temperature of the hot air to about 45° C.-60° C. over a period of 12-15 hours to synthesize dried Salicornia plant materials; and
grinding the dried Salicornia plant materials into a powder using dry grinding unit to synthesize green salt that has a low-sodium content of about 12.33 to 13.07 grams (g) per 100 g.

14. The method of claim 13, wherein the dehydration process optionally comprises performing dehumidification using a dehumidification system that removes moisture from the chopped Salicornia plant materials and surrounding environment and expels the removed moisture in liquid form.

15. The method of claim 13, wherein the green salt comprises (i) potassium of about 1.29 to 1.57 g, (ii) calcium of about 455 to 470.75 mg, (iii) iron of about 18.75 to 23.95 mg, (iv) magnesium of about 521.4 to 776.24 mg, (v) barium of about 0.065 to 0.084 mg (vi) manganese of about 1.99 to 2.38 mg, (vii) zinc of about 2.271 to 2.375 mg, (viii) copper of about 0.72 to 0.73 mg, (ix) selenium of about less than 0.05 mg and (x), phosphorous of about 56.9 to 57 mg, (xi) chloride of about 22.83 to 23.08 mg, and (xii) iodine of about 430.6 to 689.4 μg per 100 g of the green salt.

16. The method of claim 13, wherein the green salt comprises vitamins comprising (i) Vitamin B1 in an amount of 0.087 to 0.127 mg, (ii) Vitamin B2 in an amount of 0.538 to 0.948 mg, (iii) Vitamin B3 in an amount of 2.487 to 2.775 mg, (iv) Vitamin B5 in an amount of 1.263 to 1.666 mg, (v) Vitamin B6 in an amount of 0.211 to 0.228 mg, (vi) Vitamin B7 in an amount of 0.02 to 0.023 mg, (vii) Vitamin B9 in an amount of less than about 0.001 mg, (viii) Vitamin B12 in an amount of less than about 0.001 mg, (xi) Vitamin E in an amount of about 4.992 to 5.217 μg, and (x) Vitamin D in an amount of less than about 10 μg per 100 grams of the green salt.

17. A method of preparing a low-sodium green salt from Salicornia brachiata with preserved nutrients and natural color, wherein the method comprises
preparing chopped Salicornia plant materials by chopping Salicornia plants into small pieces using a cutting unit;
characterized in that,
performing a dehydration process on the chopped Salicornia plant materials using a dehydrator, wherein the dehydration process comprises
(i) initially exposing the chopped Salicornia plant materials to a hot air with a dehydration temperature of about 35° C. for 3 hours in the dehydrator, and
(ii) gradually increasing the dehydration temperature of the hot air to about 45° C.-60° C. over a period of 12-15 hours to synthesize dried Salicornia plant materials; and
grinding the dried Salicornia plant materials into a powder using dry grinding unit to synthesize green salt that has a low-sodium content of about 12.33 to 13.07 grams (g) and a high potassium content of about 1.29 to 1.57 g per 100 g.

18. The method of claim 17, wherein the green salt comprises (i) calcium of about 455 to 470.75 mg, (ii) iron of about 18.75 to 23.95 mg, (iii) magnesium of about 521.4 to 776.24 mg, (iv) barium of about 0.065 to 0.084 mg (v) manganese of about 1.99 to 2.38 mg, (vi) zinc of about 2.271 to 2.375 mg, (vii) copper of about 0.72 to 0.73 mg, (viii) selenium of about less than 0.05 mg and (ix), phosphorous of about 56.9 to 57 mg, (x) chloride of about 22.83 to 23.08 mg, and (xi) iodine of about 430.6 to 689.4 μg per 100 g.

19. The method of claim 17, wherein the green salt comprises vitamins comprising (i) Vitamin B1 in an amount of 0.087 to 0.127 mg, (ii) Vitamin B2 in an amount of 0.538 to 0.948 mg, (iii) Vitamin B3 in an amount of 2.487 to 2.775 mg, (iv) Vitamin B5 in an amount of 1.263 to 1.666 mg, (v) Vitamin B6 in an amount of 0.211 to 0.228 mg, (vi) Vitamin B7 in an amount of 0.02 to 0.023 mg, (vii) Vitamin B9 in an amount of less than about 0.001 mg, (viii) Vitamin B12 in an amount of less than about 0.001 mg, (xi) Vitamin E in an amount of about 4.992 to 5.217 μg, and (x) Vitamin D in an amount of less than about 10 μg per 100 grams.

20. The method of claim 17, wherein the green salt comprises omega fatty acids comprising (i) Omega 3 in an amount of <0.10 to 0.16 g, (ii) Omega 6 in an amount of 0.17 to 0.27 g, and (iii) Omega 9 in an amount of <0.10 to 0.11 g per 100 grams of green salt.
